(19) United States
(12) Patent Application Publication
(10) Pub. No.: US 2009/0152206 A1
(43) Pub. Date: Jun. 18, 2009

(54) Fresh water supply and delivery via flexible floating containers

(76) Inventor: William J. Kommers, Los Angeles, CA (US)

Correspondence Address: WILLIAM W. HAEFLIGER, 201 S. LAKE AVE, SUITE 512, PASADENA, CA, 91101, US

(21) Appl. No.: 12/316,521

(22) Filed: Dec. 12, 2008

Related U.S. Application Data
(60) Provisional application No. 61/007,574, filed on Dec. 14, 2007.

(51) Int. Cl. C02F 1/00

(52) U.S. Cl. 210/747; 210/170.11

(57) ABSTRACT

The method of providing fresh water to a delivery point or points associated with land, that includes providing on a seagoing vessel a desalination plant, and providing a fresh water container configured for transport in a sea water body, the container characterized as bodily expandable and collapsible; operating the plant to provide fresh water for discharge into the container adjacent the vessel, and allowing container responsive bodily expansion, transporting the container on the sea water body, directionally away from the vessel and to a location or locations for fresh water delivery from the container to a delivery point or points, and discharging fresh water from the container to a point, in conjunction with at least partial bodily collapse of the container.

This application claims priority over provisional application Ser. No. 61/007,574, filed Dec. 14, 2007.

### BACKGROUND OF THE INVENTION

This invention relates generally to provision and distribution of fresh water, as from desalination plants; more particularly it concerns an efficient system and method to transport fresh water from an offshore location to a delivery point or points associated with land.

At many locations near coastal metropolitan centers, it is currently very difficult, time consuming and expensive to obtain operating licenses, and construction and operating permits for shore-based desalination facilities. Desalination operations that are based on ocean-going vessels located in close proximity to these metropolitan centers are likely subject to the same general regulatory environment as shore-based facilities.

There is need for a method and means to desalinize sea water, for fresh water distribution, without discharge of highly saline water from the plant back into the ocean, relatively close to the shore. There is also need for means to efficiently transport desalination plants to selected offshore positions, in order to provide fresh water most efficiently to one or more selected on-shore locations or points. Efficient methods of delivery of fresh water to such different selected locations are also needed.

### SUMMARY OF THE INVENTION

It is a major object of the invention to provide a method and system meeting the above needs, as well as other related needs. Basically, the method of the invention includes:

a) providing on a seagoing vessel a desalination plant,

b) providing a fresh water container configured for transport in a sea water body, said container characterized as bodily expandable and collapsible,

c) operating said plant to provide fresh water for discharge into the container adjacent the vessel, and allowing container responsive bodily expansion,

d) transporting said container on the sea water body, directionally away from the vessel and to a location or locations for fresh water delivery from the container to said delivery point or points,

e) and discharging fresh water from the container to said point or points, in conjunction with at least partial bodily collapse of the container.

Other objects include provision of the container to be flexible, to assist fresh water filling and discharge; effecting at least partial collapse of said container to effect said discharging of fresh water; and flotation of the container in partially submerged state in the sea water body, during transport.

Additional objects include effecting container partial collapse in a way to allow sea water pressure application on submerged extent of the container, to assist fresh water discharge therefrom; providing a container upper outlet for delivery of fresh water from the container in response to pressure of sea water exerted on submerged extent of the container; and transport of the emptied and collapsed container back to the seagoing vessel for re-fill with fresh water from said plant; and providing the plant at an offshore location that may be associated with the seagoing vessel.

The basic system of the invention includes

a) a desalination plant on a seagoing vessel,

b) a fresh water container configured for transport in sea water, the container characterized as bodily expandable and collapsible,

c) the plant operating to provide fresh water for discharge into the container adjacent said plant, and allowing container responsive bodily expansion,

d) said container configured to be transportable directionally away from that plant location and to another location or locations for fresh water delivery from the container to a delivery point or points,

e) means for receiving fresh water from the container, in conjunction with at least partial bodily collapse of the container, at the delivery point or points.

These and other objects and advantages of the invention, as well as the details of an illustrative embodiment, will be more fully understood from the following specification and drawings, in which:

### DRAWING DESCRIPTION

FIGS. 1-4 show methods of fresh water floating container filling and transport;

FIGS. 5 and 6 show methods of fresh water delivery from a floatable container to a shore facility;

FIG. 7 shows sea water pressure application to a floating container;

FIGS. 8-10 show progressive collapse of a floating container as during fresh water delivery therefrom; and

FIG. 11 is an overall view of a fresh water container filling, transport, and discharge at selected on-shore locations.

### DETAILED DESCRIPTION

Referring first to FIG. 11, it shows, in plan view an offshore desalination plant 10, as on a seagoing vessel 9 positioned in the ocean 11 at an offshore location, relative to land 12. Shore is indicated at 13. Selected spaced apart points of delivery of fresh water are indicated at 14, 15 and 16 adjacent the shore. Those points may be associated with towns or cities needing fresh water. The plant location offshore is typically such that concentrated saline discharged back into the ocean does not contaminate the shore.

Towable and floatable fresh water containers are shown at 17a, 17b, and 17c. Container 17a is shown maneuvered into position adjacent desalination plant 10b, to receive fresh water at 18. That container is typically expandable, as during filling with fresh water.

Container 17b is shown being towed via tug 20 in a direction 21 away from plant 10 on vessel 9, and toward delivery point 14 at or proximate shore 13, and associated with a facility or facilities 23 (such as a community) needing fresh water as via receiver 24. Container 17c is shown at or proximate delivery point 16, fresh water being delivered at 26, via 16, to a receiver 27, on shore. Point 16 and receiver 27 are associated with a different community 28 needing fresh water. Another such community and receiver are indicated at 29 and 30. In this way, fresh water can be efficiently and selectively supplied to one or more facilities on land, and spaced apart, and as fresh water is needed. Emptied and collapsed containers 17a, 17b and 17c present little resistance to towing back to 9, due to their collapse.

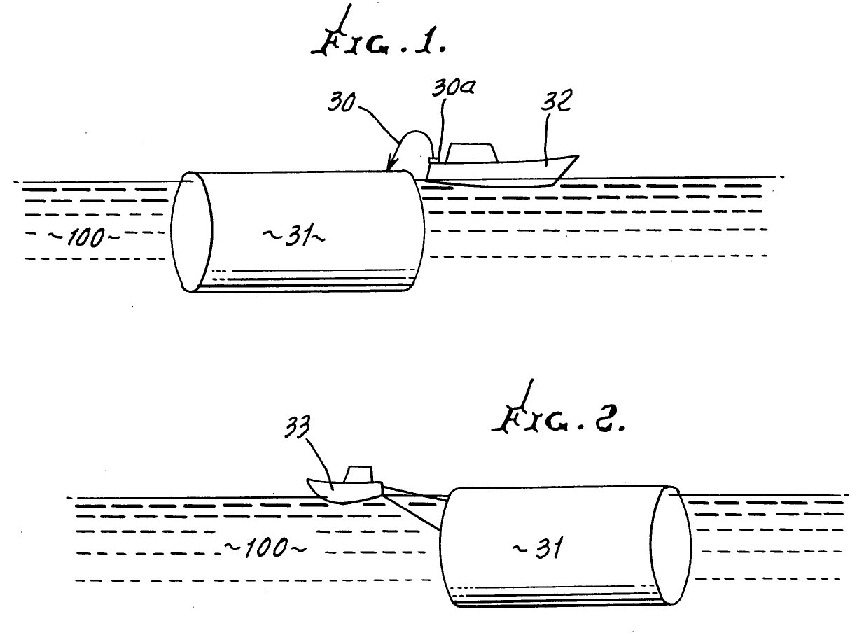

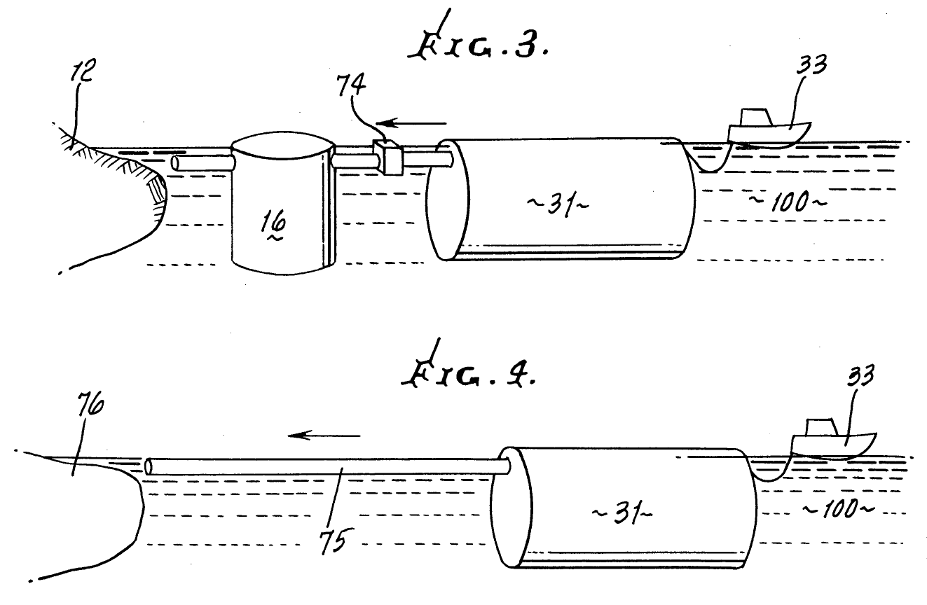

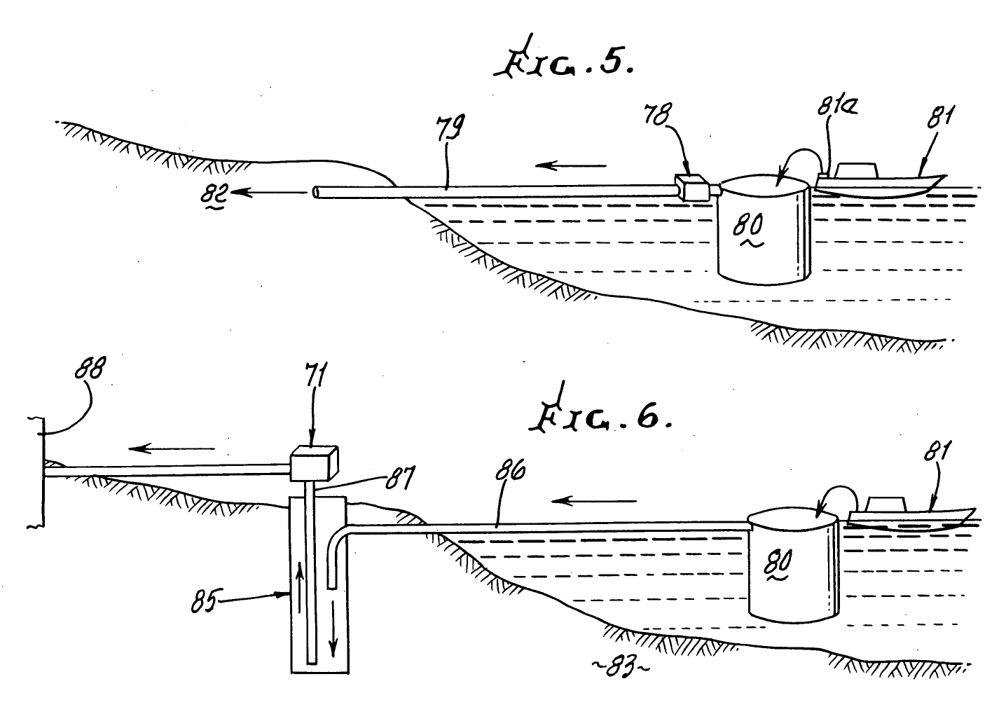

Referring now to FIGS. 1-4, they schematically show filling of fresh water at 30 into a floating expandable and collapsible container 31, as from a desalination plant 30a on a seagoing vessel 32; towing at 33 in FIG. 2 of the container 31; substantially submerged in the ocean 100; transfer, as by pump 74, of fresh water from container 31 to a storage tank 16 proximate land 12 in FIG. 3; and direct transfer at 75 in FIG. 4 of fresh water from container 31 to an on-shore fresh water system 76.

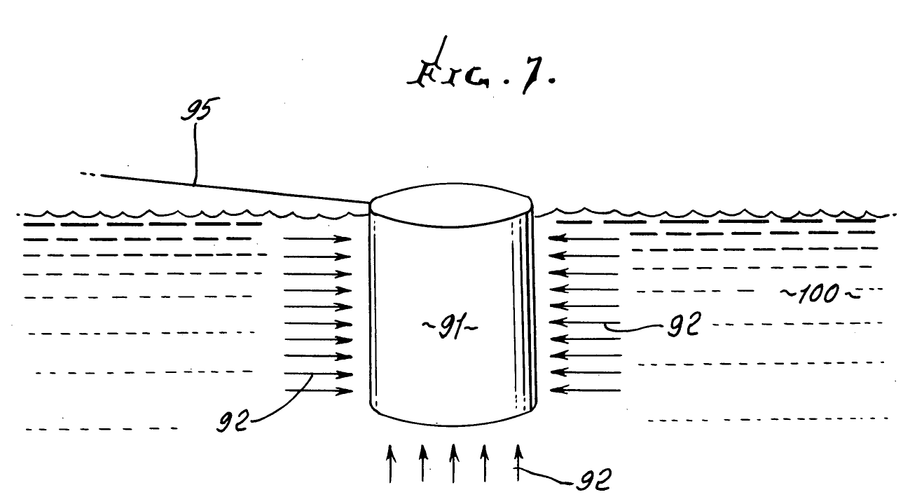

FIG. 5 is like FIG. 4, but shows transfer as via pump 78 and pipe 79, of fresh water from a modified submerged fresh water storage container 80 adjacent the seagoing vessel 81 supporting the desalination plant 81a. Pipe 79 delivers fresh water to the on-shore facility 82. FIG. 6 shows a storage tank 85 located on land 82, and being filled with fresh water from submerged storage container 80, via pipe 86. Water is pumped at 87 from tank 85 for delivery to use facilities 88.

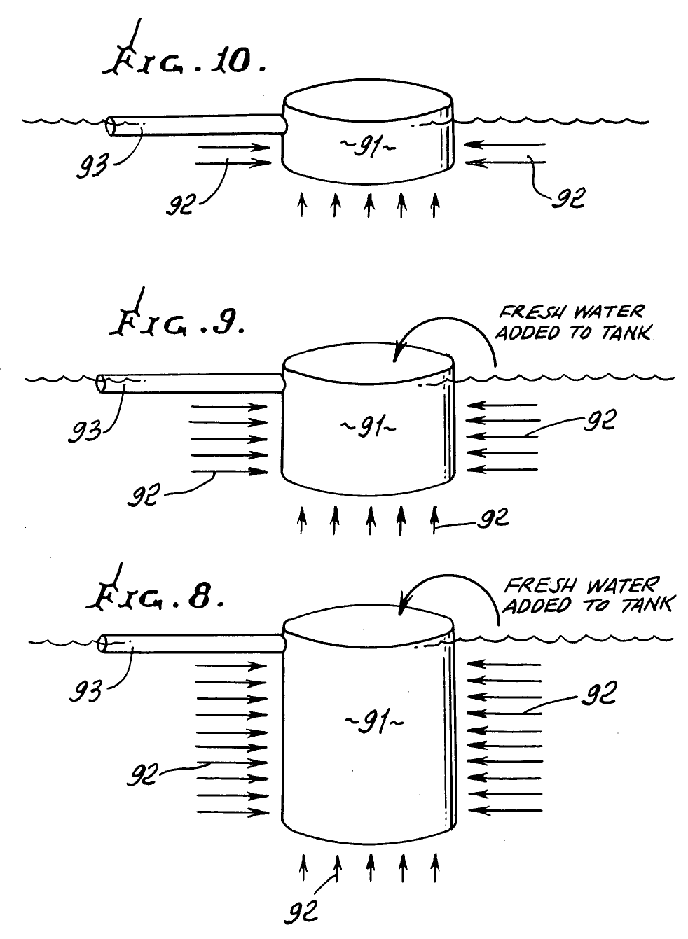

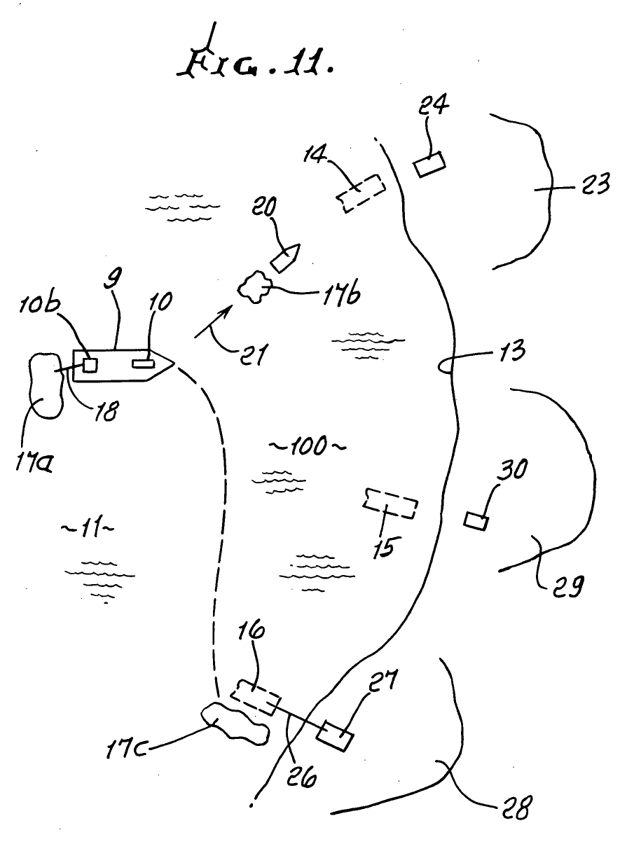

FIGS. 8, 9, and 10 show progressive collapse of a flexible submerged container 91 in response to sea water pressure exertions at 92 (see arrows), during delivery of fresh water from the flexible wall container via pipe 93 to on-shore facilities.

FIG. 7 is like FIG. 8, but shows storage of fresh water in container 91, off-shore, that filled container being towable, as via line 95.

What is claimed is:

1. The method of providing fresh water to a delivery point or points associated with land, that includes
a) providing on a seagoing vessel a desalination plant,
b) providing a fresh water container configured for transport in a sea water body, said container characterized as bodily expandable and collapsible,
c) operating said plant to provide fresh water for discharge into the container adjacent the vessel, and allowing container responsive bodily expansion,
d) transporting said container on the sea water body, directionally away from the vessel and to a location or locations for fresh water delivery from the container to said delivery point or points,
e) and discharging fresh water from the container to said point, in conjunction with at least partial bodily collapse of the container.

2. The method of claim 1 wherein said container is provided to be flexible.

3. The method of claim 2 wherein said step e) includes effecting at least partial collapse of said container to effect said discharging of fresh water.

4. The method of claim 2 wherein said container is floated in partially submerged state in said sea water, during said transporting.

5. The method of claim 3 wherein said partial collapse is effected by allowing pressure of sea water to be applied to a container wall to displace said wall operating to force fresh water from the container.

6. The method of claim 1 wherein said step d) includes providing and operating a tug to travel said floating container toward the delivery point.

7. The method of claim 1 wherein major extent of the container is submerged in the sea water body during said step d) transporting.

8. The method of claim 7 wherein the container has an upper outlet for delivery of fresh water from the container in response to pressure of sea water exerted on submerged extent of the container.

9. The method of claim 1 including transporting the emptied container back to the seagoing vessel for re-fill with fresh water from said plant.

10. The method of providing fresh water to a delivery point associated with land, that includes
a) providing a desalination plant at an offshore location,
b) providing a fresh water container configured for transport in a sea water body, said container characterized as bodily expandable and collapsible,
c) operating said plant to provide fresh water for discharge into the container adjacent said location, and allowing container responsive bodily expansion,
d) transporting said container on the sea water body, directionally away from that location and to another location or locations for fresh water delivery from the container to said delivery point,
e) and discharging fresh water from the container to said point, in conjunction with at least partial bodily collapse of the container.

11. A system for providing fresh water to a delivery point associated with land, that comprises
a) a desalination plant on a seagoing vessel,
b) a fresh water container configured for transport in a sea water body, said container characterized as bodily expandable and collapsible,
c) said plant operating to provide fresh water for discharge into the container adjacent said location, and allowing container responsive bodily expansion,
d) said container on the sea water body, configured to be transportable directionally away from that location and to another location or locations for fresh water delivery from the container to said delivery point,
e) means for receiving from the containers at said point, in conjunction with at least partial bodily collapse of the container.

12. The system of claim 11 wherein said container is provided to be flexible to accurately collapse.

13. The system of claim 12 wherein said container is floated in partially submerged state in said sea water during said transporting.

14. The system of claim 11 wherein said partial collapse is effected by pressure of sea water to be applied to a container wall to displace said wall operating to force fresh water from the container.

15. A system for providing fresh water to a delivery point associated with land, that comprises
a) a desalination plant at an offshore location,
b) a fresh water container configured for transport in a sea water body, said container characterized as bodily expandable and collapsible,
c) said plant operating to provide fresh water for discharge into the container adjacent said location, and allowing container responsive bodily expansion,
d) said container configured to be transportable on the sea water body, directionally away from that location and to another location for fresh water delivery from the container to said delivery point,
e) means for receiving fresh water from the container at said point, in conjunction with at least partial bodily collapse of the container.

16. The system of claim 11 wherein the container has an upper outlet for delivery of fresh water from the container in response to pressure of sea water exerted on submerged extent of the container.

17. The system of claim 16 wherein a major extent of the container is submerged in the sea water body during said transporting.
